(19) United States
(12) Patent Application Publication
(10) Pub. No.: US 2010/0115856 A1
(43) Pub. Date: May 13, 2010

(54) Tower sector frame antenna mount

(76) Inventors: Donald C. Carlisle, Cordova, TN (US); Guy L. Faries, Memphis, TN (US)

Correspondence Address: Paul M. Denk, 763 South New Ballas Rd. Ste 305, St. Louis, MO, 63141, US

(21) Appl. No.: 12/657,132

(22) Filed: Jan. 14, 2010

Related U.S. Application Data
(63) Continuation of application No. 11/433,011, filed on May 12, 2006, now abandoned.
(60) Provisional application No. 60/681,694, filed on May 17, 2005.

(51) Int. Cl. H01Q 1/12; E04H 12/00

(52) U.S. Cl. 52/40; 52/173.1

(57) ABSTRACT

An improvement for an aluminum lattice sector frame of the type used for supporting wireless communications antennas and designed to be mounted on a communication tower, is provided. Mating extruded components are used to provide fixed connections which restrict relative rotation and translation between connected parts while presenting a round tubular outside cross-sectional profile thereby reducing the effective projected wind load area of the frame. The fixed component connections greatly reduce the overall deflection of the frame under applied combined dead, wind and ice loading.

### CROSS REFERENCE TO RELATED APPLICATION

This continuation patent application claims priority to the non provisional patent application having Ser. No. 11/433,011, filed May 12, 2006, which claims priority to the provisional patent application having Ser. No. 60/681,694, having filing date May 12, 2006.

### FIELD OF INVENTION

This invention relates to mounting system frames used to support wireless communications antennas. Such mounting frames are used to position the communications antennas at an appropriate location to allow the antennas to function.

### BACKGROUND OF THE INVENTION

This invention relates to mounting system frames used to support wireless communications antennas. Such mounting frames are used to position the communications antennas at an appropriate location to allow the antennas to function. The most common application is to mount the antenna frame to a communications tower. The frame is designed to support the loads applied to the antennas as well as to the frame itself and then transfer the loads into the supporting communications tower. Typical loads that must be considered are dead gravity loads (e.g., self weight, and man loads and ice accumulation), wind, and ice accumulated on the antennas and the frame and dynamic loads such as wind effects. Various antenna mounting systems have been employed in the past, constructed of both aluminum and steel. Although the mounting system frame must be able to maintain the correct orientation of the antennas relative to the communications tower, one of the most critical aspects of the frame system design is the magnitude control of the loads being transferred into the supporting structure. To this end, any inventions that will reduce the magnitude of these the transferred loads will be desirable.

Design standard ANSI/EIA/TIA-222 is used by the communications industry to develop structural designs for communication towers as well as any appurtenance that may be attached to the tower. The current revision of this standard (ANSI/EIA/TIA-222-FG), although comprehensive in scope, still leaves considerable room for interpretation by the designer. For this as well as other reasons the responsible EIA/TIA standards committee is in the process of preparing a new revision (ANSI/EIA/TIA-222-G) which will continuously review the standard document and periodically issues revisions of ANSI/EIA/TIA-222 in an effort to take some of the ambiguity out of the design process. However, existing products have been designed to previous revisions of the standard. Therefore, significant sector frame design variations exist which may or may not satisfy the newest and more rigorous version of the ANSI/EIA/TIA-222 standards. Most sector frames currently on the market are constructed of steel and are therefore extremely heavy. The heavy weight construction of steel sector frames makes installation on a communications tower very difficult. In addition, the sector frame weight imparts an eccentric vertical load into the communications tower which that must be supported by the tower structure. This large eccentric vertical load results in the need for heavier duty structural components within the tower for support at the connection, as well as the need for a stronger tower foundation to resist the additional ground line moment created by the offset vertical load.

Traditionally, antenna mount lattice sector frames have been constructed primarily out of structural steel angle shapes. These shapes have a flat surface, regardless of the orientation, which results in an inefficient design with regard to resistance to wind loads. When calculating estimated wind loads using design standards, multiplication shape factors must be applied to the cross-sectional projected surface areas of the individual frame members that are multiplied by shape correction factors, increasing the calculated wind load surface area. Flat shapes are the communications industry design standards assigned wind load shape correction factors to flat profile shapes that are of considerably larger magnitude than the shape correction factors assigned to round profile shapes. Therefore, antenna mount sector frames constructed with round profile shapes should enjoy the technical design benefit of reduced effective projected wind load area when compared to similar size sector frames constructed using structural angles.

The nature of steel structural shapes allow for welding of materials permits the design and manufacture of welded steel connections without any significant loss in material strength, thus providing fully fixed, full strength, inter-component connections and thereby reducing deflections under load. Unfortunately, extruded structural aluminum shapes typically do undergo a significant reduction of strength in the immediate area of a welded connection due to the loss of extrusion heat treatment properties. Therefore, a method of constructing a fully fixed aluminum structural component connection, without the use of welding, is desirable.

Thus, there exists a need for a wireless communications antenna mounting frame system that is light weight, has a low effective projected wind load area, and provides fully fixed inter-component connections without the use of welding. To this end, there is invented herein, an improved design which we believe will satisfy all of these requirements.

### SUMMARY OF THE INVENTION

The present invention improves existing frames by utilizing light weight aluminum mated extrusion designs which restrict the rotation and translation of individual structural members within the frame. The improved frame is constructed of custom designed tubular sections which form the upper and lower beams of the frame. Tubular column members are used to connect the upper and lower beams establishing the appropriate vertical spacing between the beam members. Additional tubular members are installed at an angle in a fixed angular orientation relative to the upper and lower beams forming truss style webbing, which increases the rigidity of the entire frame. The interior cross-sections of the tubes of the tubular members are designed to mate with extruded inserts in a manner which limits any relative rotation between connected components. Additionally, bolts pass through the tube and the internal mated extrusion establishing a fixed connection that can neither rotate nor translate. Since the connections are made with internal fittings the round external cross-section profiles of the structural shapes are maintained, reducing and thus minimizing the overall effective projected wind load area of the frame.

When fixed connections between components are used, the application of loads results in the development of tension, compression and bending forces within individual members of the frame. Open structural shapes such as angles and channels are highly susceptible to combined compression and bending. Specifically, local or member buckling can occur. Tubular shapes are considered closed structural shapes, meaning they are not as likely to buckle when subjected to combined compression and bending, making the improved design very stable thus providing another benefit of the present invention.

The current invention mounts to a communications tower using custom extrusion designs which allow and permit attachment of the frame to attach to either round tubular or structural angle tower members forming the tower. Antennas are attached to the front face of the frame using custom designed pipe clamps. The tubular construction of the mounting face allows the antennas to be easily adjusted and positioned located anywhere along the length of the front face.

Due to the light weight of aluminum extrusions as constructed into the invention, such permits the antenna mounting frame to be easily hoisted into its mounting attachment position on the communications tower. Once the frame is mounted and attached to the communications tower, the antennas typically must be adjusted to the proper orientation. With improved rigid design construction, work crews can install and service the antennas without being exposed to unsafe movement of the frame.

Therefore, it is an object of the invention to provide an improved light weight alternative to steel antenna mounting frames.

It is a further object of the present invention to provide fixed inter-component mechanical connections which resist both relative rotation and displacement of the individual connected structural members.

A further object of the invention is to provide an antenna mount sector frame that permits easy adjustment of the individual antenna mounting locations anywhere along the length of the front face of the frame.

It is a still further object of the present invention to provide frame members which have a round tubular external cross-sectional profile, which reduces the effective projected wind load area of the antenna mount frame thereby reducing the loads applied by the wind to the antenna mount and the communications structure to which it is attached.

These and other objects may become more apparent to those skilled in the art upon review of the summary of the invention as provided herein.

### BRIEF DESCRIPTION OF THE DRAWINGS

In referring to the drawings:

FIG. 1 shows an isometric view of the sector frame;

FIG. 2 is a detail view showing the connection used at the junction of the vertical and diagonal webbing members to form the connection with the horizontal beam members, as shown at 2-2 of FIG. 1;

FIG. 3 is a detail view showing the fully fixed connection used to attach the bottom horizontal beam on the center panel to the bottom horizontal beam on the front panel, as shown at 3-3 of FIG. 1;

FIG. 3A is an exploded detail view demonstrating how an insert member slideably connects two sections of the horizontal beam members in the front panel, as shown in FIG. 3;

FIG. 3B is an exploded detail view showing how the placement of insert member bolts are secured in the aligned holes, thereby completing the connection of two beam sections and insert member, thereby creating a single horizontal beam member; as shown in FIG. 3;

FIG. 3C is an exploded detail view demonstrating how an insert member slideably connects the horizontal beam on the center panel to the horizontal beam on the front panel;

FIG. 3D is an exploded detail view showing how after placement of insert member bolts are secured in the aligned holes, thereby completing the connection;

FIG. 4 is a detail view showing the connection used to attach the beam on the side panels to the beam on the front panel;

FIG. 5 is a detail view showing the double-T connector used to attach the center, left, and right frames or panels together at the tower side of the frame, and also shown are clamping members used to attach the sector frame to the communications tower;

FIG. 6 is a detail view showing the fully fixed connection used at the junction of the diagonal webbing members to form the connection with the horizontal beam members;

FIG. 6A is an exploded assembly detail demonstrating how an insert member slideably connects two sections of the diagonal webbing members and in turn connects the webbing members to the upper horizontal beam member using a pipe clip member;

FIG. 6B is an exploded view detailing how in placement of the insert member, bolts are secured in the aligned holes, thereby completing the connection of the webbing members to the upper horizontal beam member; and

FIG. 7 is a detail view showing the connection used to attach the vertical webbing members to the horizontal beam members, taken on the line 7-7 of FIG. 1.

### DESCRIPTION OF THE PREFERRED EMBODIMENT

The present art overcomes prior limitations by providing a light weight sector wireless communications antenna mounting frame with fixed inter-component structural connections that resist rotation and translation while maintaining the round tubular outside cross-sectional profile of the structural components. The tubular outside cross-sectional use of round profile components and connections results in a low effective projected wind load area, which in turn reduces the wind load effects transferred to the connected communications tower.

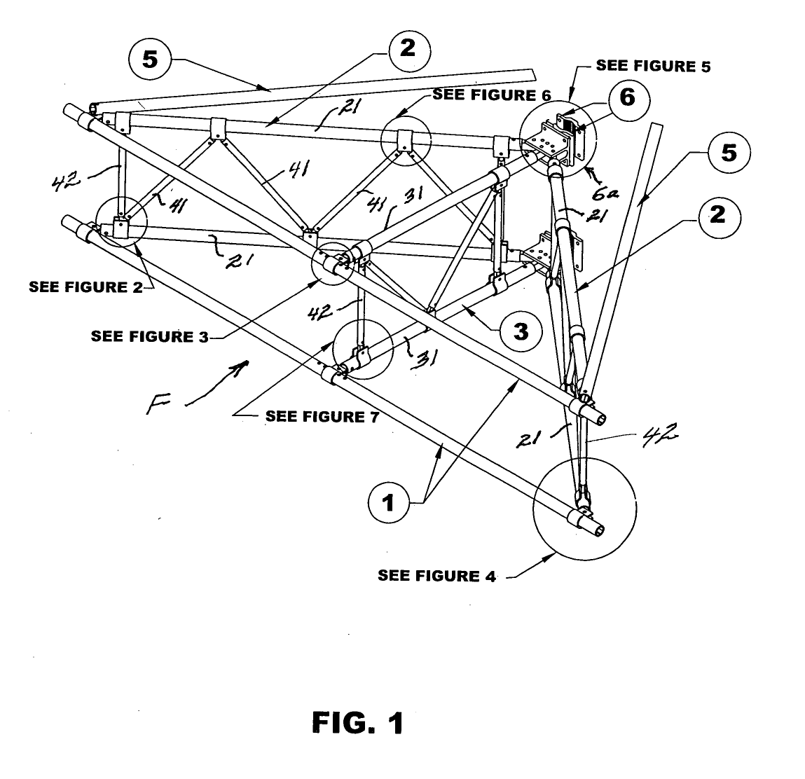

Turning to FIG. 1, the communication antennas (not shown) are mounted to the front face tubular beam members 1 of the sector front frame F. The sector frame is attached to a communications tower by way of clamping device bracket 6a. Tubular or angular tower members are sandwiched between opposing members of the clamping devices 6. Attachment hardware, in the form of threaded bolts, pass through horizontally oriented holes in the clamping device and in turn pass through matching holes in the bracket 6a. The bracket forms the frame members apex of the generally triangular shaped sector frame F. Three two lattice framed outside or outer frames or panels 2 and one intermediate center frame or panel 3, extend outward from the bracket 6a toward the front face tubular beam members with the central frame 3 being shorter than the two outside frames 2. The front frame or panel and its front face beams 1 are connected to the two outside panels 2 as well as the center panel 3, forming the generally triangular shape of the sector frame F. Tubular webbing, as at 42, and angular support members 41 extend generally vertically and diagonally between the upper and lower beams of the three lattice-frames and panels 2 and 3. In the preferred embodiment there are two stabilizing arms 5 each attached at one end to the front frame and extending horizontally back and attaching to the communications tower, thus helping to reduce movement of the sector frame F relative to the tower.

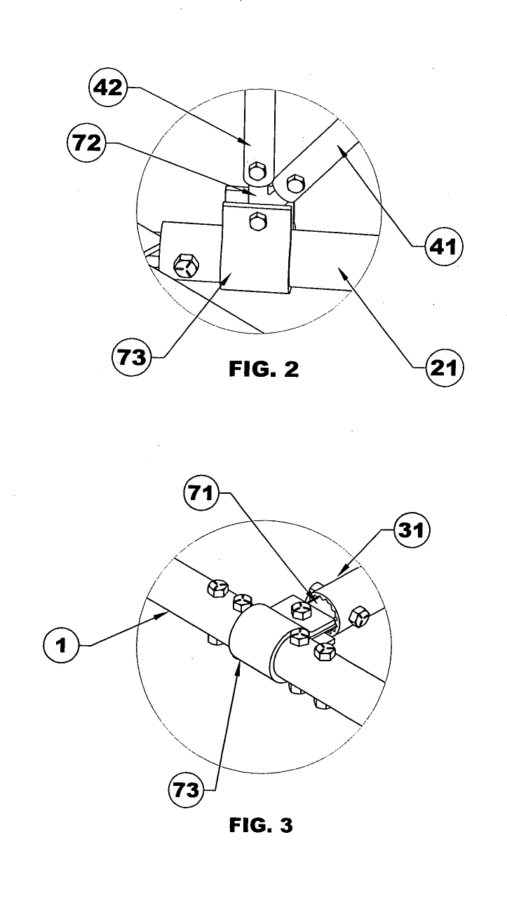

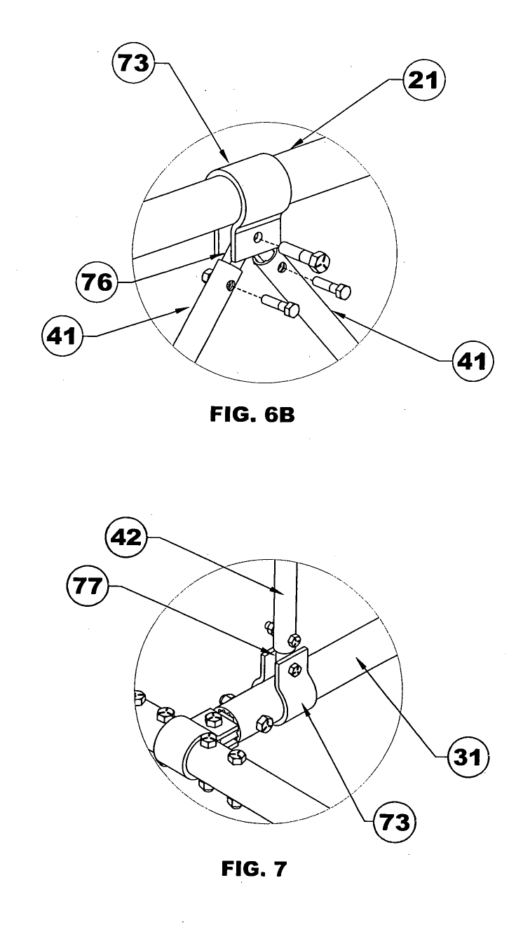

The details in FIG. 1 are shown in greater clarity in FIG. 2 thru FIG. 7. Beginning with FIG. 2, therein is shown the connection used to join vertical beam 42 and diagonal webbing members 41 to horizontal beam member 21. A generally V-shaped extruded aluminum member 72, hereinafter referred to as little-V, is slideably inserted into the webbing members 41 and 42, which have internal cross-sections that mate with the external cross-sections of the little-V member 72, thus fixing the inter-component connections against rotation. The cross section of the tube members may be a serration as can be seen. The connections between members 41, 42 and member 72 are fixed against translation by inserting and securing bolts (not shown) through aligning holes in members 41, 42 and 72. Pipe clip member 73 is an extruded aluminum shape which has a generally round portion designed to mate with the external cross-section of the horizontal beam member 21. Two parallel legs extend out from the rounded section of member 73 with aligned holes passing through the legs. The end of the little-V member 72, opposite the end inserted into webbing members 41 and 42, is sandwiched between the parallel legs of pipe clip member 73. The connection between member 72 and member 73 is completed by inserting and securing a bolt (not shown) through aligning holes in members 72 and 73, and tightening the bolt and thus clamping and securing the webbing members 41 and 42 to the horizontal tubular beam 21.

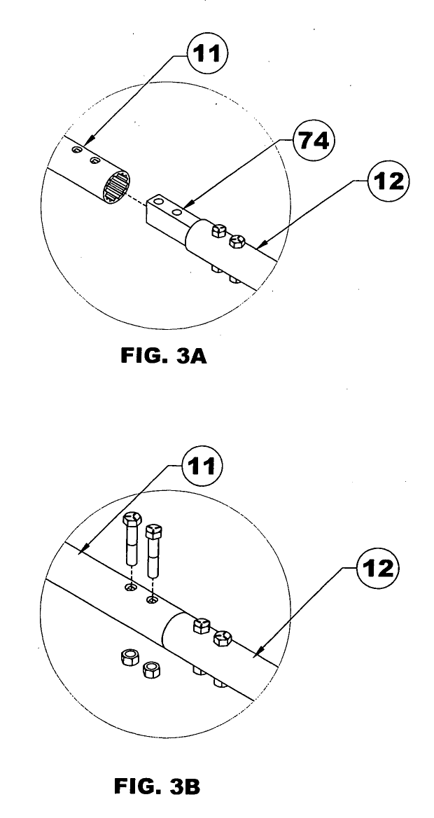

Moving to FIG. 3, therein as shown the fully fixed connection used to join front panel horizontal beam member 1 to the center panel horizontal beam member 31. A generally rectangular shaped extruded aluminum member 71 hereinafter referred to as a duck bill is slideably inserted into the center panel horizontal member 31 which has an internal cross-section, serrated as shown, that mates with the external cross-section of the duck bill 71 fixing the inter-component connection against rotation. The connection between the center panel tubular beam member 31 and member 71 is fixed against translation by inserting and securing a bolt through aligning holes in center panel member 31 and duck bill 71. Pipe clip member 73 is an extruded aluminum shape which has a generally round portion designed to mate with the external cross-section of front panel horizontal beam member 1. Two parallel legs extend out from the rounded section of member 73 with aligned holes passing through the legs. The end of duck bill member 71 opposite the end inserted into member 31 is sandwiched between parallel legs of pipe clip member 73. The connection between member 71 and member 73 is completed by inserting and securing a bolt through aligning holes in members 71 and 73, tightening the bolt and thus clamping and securing the front panel horizontal beam member 1 to the center panel horizontal beam member 31.

In review of FIG. 3A, partially hidden is extruded aluminum insert member 74 hereinafter referred to as a UP Fitting. UP Fitting 74 has a generally rectangular external cross-section which is designed to slideably mate with the internal cross-section of horizontal pipe members 11 and 12. Member 74 is used to connect, end to end, two sections of pipe to create an end-to-end connection of the two pipe members 11 and 12 that is fixed against relative rotation and translation of the connected members, thus forming a complete single continuous beam member 1 fixed against relative rotation. FIG. 3B demonstrates how the connection between pipe members 11 and 12 are is fixed against relative translation by inserting and securing bolts through aligning holes in members 11, 12 and the UP Fitting 74 (which is hidden from view in FIG. 3B).

Moving to FIG. 3C, an aluminum insert duck bill member 71 has a generally rectangular external cross-section which is designed to slideably mate with the serrated internal cross-section of horizontal pipe tubular beam member 31. Member 71 is used to connect center panel horizontal beam member 31 to the front panel horizontal beam member 1, through pipe clip member 73, and to fix the connection inter-connected components against relative rotation and translation. FIG. 3D demonstrates how the connections between members 31 and 1 are fixed against translation by securing bolts through aligning holes in members 31 and 71 as well as members 71 and 73.

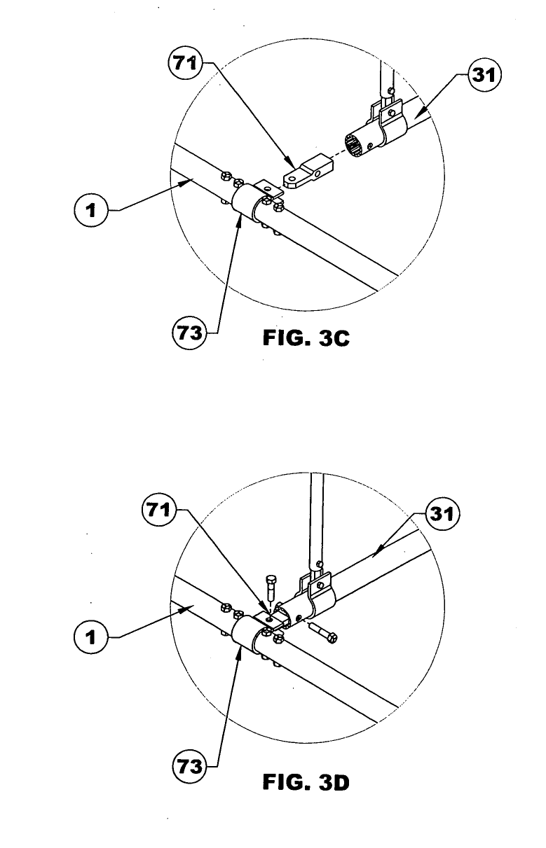

Turning to FIG. 4, therein as shown the connection used to join front panel horizontal beam member 1 to the side panel horizontal beam member 21. Similar to FIG. 3, duck bill member 71 is slideably inserted into the side panel horizontal beam member 21, which has an internal cross-section that mates with the external cross-section of the duck bill 71 fixing the inter-component connection against relative rotation. The connection between side panel member 21 and member 71 is fixed against translation by inserting and securing a bolt (not shown) through aligning holes in side panel horizontal beam member 21 and duck bill 71. Pipe clip member 73 is used to mate with the external cross-section of front panel horizontal beam member 1. The end of duck bill member 71, opposite the end inserted into side panel horizontal beam member 21, is sandwiched between parallel legs of pipe clip member 73. The connection between member 71 and member 73 is completed by inserting and securing a bolt (not shown) through aligning holes in members 71 and 73, tightening the bolt and thus clamping and securing the front panel horizontal beam member 1 to the side panel horizontal beam member 21.

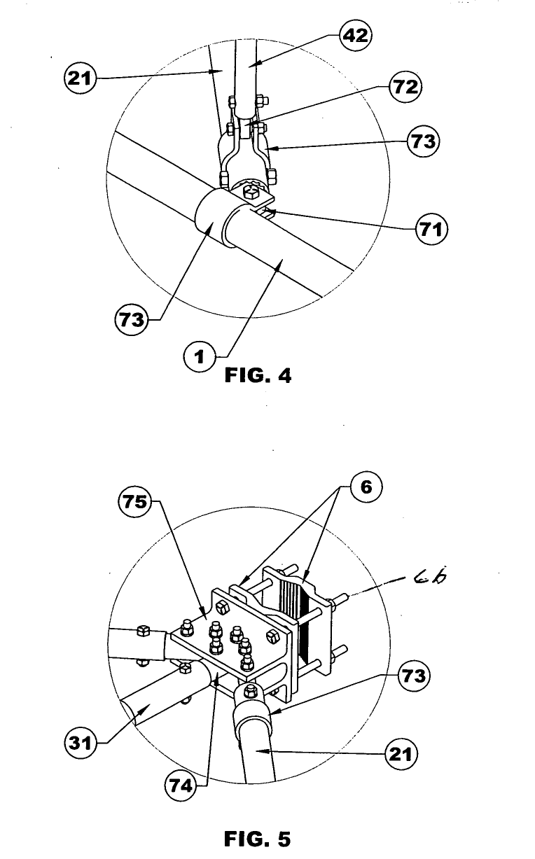

Moving on to FIG. 5, detailing the connector member 75 hereinafter referred to as double-T connector, as well as the clamping members 6 hereinafter referred to as PA bracket 6a. PA clamp members 6 are used to attach the sector frame to a communications tower. A fixed vertical structural member of the communication tower (not shown) is sandwiched between two opposite facing PA clamps members 6. The PA clamp is fixed in position, relative to the communications tower, by secured tightening bolts 6b passing through aligning holes in members 6, thus providing the needed clamping force. The PA clamp bolts used to secure members 11 in position relative to the communications tower also pass through double-T member 75, thus securing members 6 and member 75 together, and thereby securing the sector frame to the communications tower structure. The double-T member 75 forms the apex of the generally triangular shaped sector frame, bringing the center 3 and side panels 2 of both the top and bottom horizontal beam members 1 together, at the end opposite the front panel. UP fitting member 74 (detailed in FIG. 3A) has a generally rectangular shape mating with the internal cross-sections of horizontal beam members 21 and 31 and is fixed in position by securing bolts (not shown) in the aligned holes. The ends of UP fitting members 74, opposite the connections with members 21 and 31, is are sandwiched between the upper and lower horizontal legs of double-T member 75. Aligned vertically oriented holes in UP fitting members 74 and double-T member 75 allow for the placement and securing of bolts (not shown) to fix the connections against relative rotation and translation.

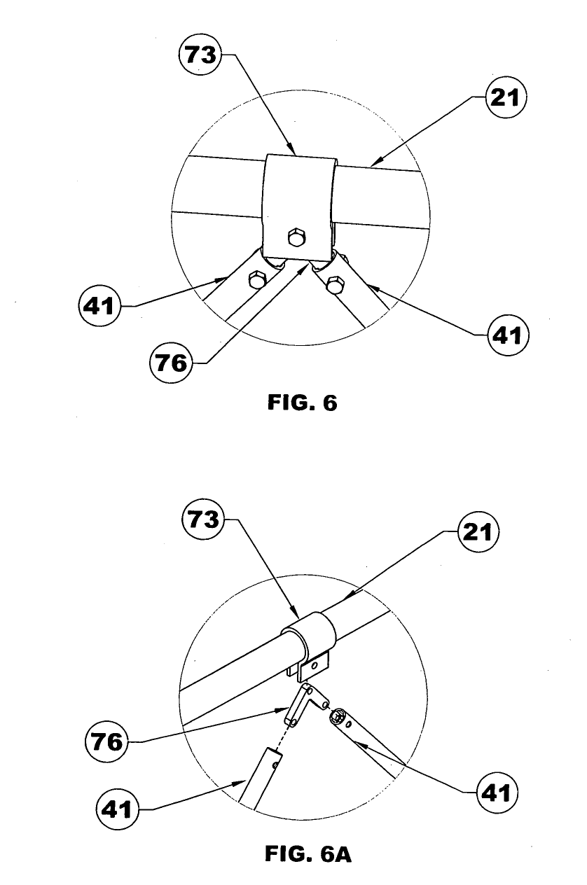

Turning to FIG. 6, the fully fixed connection used to join diagonal webbing members 41 to horizontal beam member 21 is shown, similar to previously defined fittings.

Continuing with FIG. 6A, a generally V-shaped extruded aluminum member 76 hereinafter referred to as big-V is slideably inserted into the webbing members 41 which each have an internal cross-section that mates with one leg of the external cross-section of the big-V member 76, thereby fixing the connected parts against relative rotation. Pipe clip member 73 is an extruded aluminum shape which has a generally round portion designed to mate with the external cross-section of horizontal beam member 21. Two parallel legs extend out from the rounded section of member 73 with aligned holes passing through the legs. The end of big-V member 76, opposite the ends inserted into diagonal webbing members 41, is sandwiched between the parallel legs of pipe clip member 73. Referring to FIG. 6B, the connection between big-V member 76 and member 73 is fixed against translation by inserting and securing a bolt through aligning holes in members 76 and 73. Likewise, the connections between members 41 and member 76 are fixed against translation by inserting and securing bolts through aligning holes in said members 41 and 76.

Finishing with FIG. 7, a connection is shown for the attachment of vertical webbing member 42 to the horizontal beam member 31. A generally rectangular shaped aluminum extrusion member 77 hereinafter referred to as LUP fitting, is slideably inserted into vertical webbing member 42 having an internal cross-section matching the external cross-section of member 77, thus fixing the inter-component connection against relative rotation. Pipe clip member 73 is an extruded aluminum shape which has a generally round portion designed to mate with the external cross-section of horizontal beam member 31. Two parallel legs extend out from the rounded section of member 73 with aligned holes passing through the legs. The end of LUP member 77, opposite the connection with webbing member 42, is sandwiched between the parallel legs of pipe clip member 73. Aligned holes in webbing members 42 and 77 as well as in members 77 and 73 allow the connections to be fixed against translation by securing bolts (as shown) in the holes.

Variations or modifications to the subject matter this invention may occur to those skilled in the art upon review of this summary of the invention is provided herein, and upon undertaking a study of the description of its preferred embodiment. Such variations, if within the scope of this invention, are intended to be encompassed within the claims to invention as obtained herein. The description of the preferred embodiment, and its depiction in the drawings, is set forth for illustrative purposes only.

15. The tower sector frame antenna mount of claim 17, and including a pair of stabilizing arms, one of each stabilizing arm connecting to an end of the upper tubular member of the front frame and being secured at their opposite ends to the same pole of the communications tower secure the antenna mount in place during usage.

17. A tower sector frame antenna mount or use in wireless communications to mount antennas to a pole, said mount including a front frame, a pair of sides frames, said pair of side frames at one end connecting to the front frame at spaced locations, and said pair of side frames converging rearwardly and towards each other into proximity at their back ends, clamping devices connecting to the opposite and back ends of the side frames, and provided for clamping of the antenna mount to any communications tower, an intermediate frame, said intermediate frame connecting at the approximate midpoint to the front frame, and extending rearwardly fro connecting with the clamping devices, to add reinforcement to the sector frame during its usage, said front frame incorporating upper and lower tubular beam members in its construction, said beam members extending in parallel laterally with respect to the structured mount, each of the side frames and intermediate frame incorporating upper and lower beams in their structure, there being two clamping devices operatively associated with the upper and lower tubular beam members forming the side and central frames, and attaching the mount to the pole of the communications tower, vertical tubular beam members provided between the upper and lower tubular beam members forming the side and intermediate frames, to provide for their structured spacing in their respective frames when mounting the front frame to any communications tower, each of the side and intermediate frames having diagonal webbing members extending angularly between the upper and lower tubular beam members of the side and intermediate frames, to reinforce said frames in their support for the front frame off of the communications tower, the tubular beam members forming the upper and lower beams for each of the front, sides and intermediate frames, and the vertical beams and diagonal webbing members providing support intermediate thereof or formed of annular components to reduce when resistance of the mount when utilized upon a communications tower, said clamping members securing the side and intermediate frames to the communications tower incorporate a pair of opposite facing clamp members that affixed to the tower, and which secure to the opposite ends of the upper and lower beams, the front face of each of the clamping members include a pair of integrally forwardly extending plates, that are fasten to the opposite ends of the upper and lower, beams of the side and intermediate frames, and a fitting having a shape to engagingly fit within in the approximate end of its associated upper and lower beam, and being fasten therewith, and said fitting extending into the space between the pair of the front face clamping deices to secure the frames to the communications tower, each of the upper and lower tubular beam members of the side and intermediate frames engaged by clip members to the upper and lower beam members of the front frames, the being a fitting connected into the approximate ends of the upper and lower tubular members of the side and intermediate frame, and said fittings being secured therein, each of said tubular members being formed interiorly having annual creations to cooperate with the fittings to prevent the upper and lower tubular members from turning once their fittings have secured them in place, said fittings cooperating with the clip members to secure the side and intermediate frames to the front frame for the antenna mount, the ends of each beam member having serration, internally to secure the fittings therein, and wherein the tubular beam members forming the front, sides and intermediate frames, in addition to the vertical beams, or fabricated of aluminum.
